(19) United States
(12) Patent Application Publication
(10) Pub. No.: US 2024/0354311 A1
(43) Pub. Date: Oct. 24, 2024

(54) DATA MAPPING USING STRUCTURED AND UNSTRUCTURED DATA

(71) Applicant: INTERNATIONAL BUSINESS MACHINES CORPORATION, Armonk, NY (US)

(72) Inventors: Shubhi ASTHANA, Santa Clara, CA (US); Ruchi MAHINDRU, Elmsford, NY (US)

(21) Appl. No.: 18/303,792

(22) Filed: Apr. 20, 2023

(51) Int. Cl. G06F 16/25; G06F 16/22; G06F 16/35; G06F 16/383

(52) U.S. Cl. CPC G06F 16/258; G06F 16/221; G06F 16/35; G06F 16/383

(57) ABSTRACT

Structured data and unstructured data to be mapped are obtained. Using the structured data, which includes a plurality of columns, and the unstructured data mapping is automatically performed to provide a mapping output. The mapping output includes at least one mapping between a selected column of the plurality of columns and another column of the plurality of columns and a mapping of selected data of the unstructured data to at least one column of the plurality of columns. Multiple mappings of a given column are automatically resolved to provide a revised mapping output, based on there being more than one mapping of the given column. One or more actions are performed, based on, at least, one of the mapping output and the revised mapping output.

### BACKGROUND

One or more aspects relate, in general, to facilitating processing within a computing environment, and in particular, to facilitating performance of data mapping within the computing environment.

Data mapping is employed to correlate data of different data sources. Each organization and even different departments within an organization may represent data differently. For instance, one organization may refer to a processor of a computing environment by an identification, another by id, another by name, etc. Due to the differences, it is, at times, beneficial to map different data representations.

### SUMMARY

Shortcomings of the prior art are overcome, and additional advantages are provided through the provision of a computer-implemented method of facilitating processing within a computing environment. The computer-implemented method includes obtaining structured data and unstructured data to be mapped. The structured data includes a plurality of columns. Mapping is automatically performed using the structured data and the unstructured data to provide a mapping output. The mapping output includes at least one mapping between a selected column of the plurality of columns and another column of the plurality of columns and a mapping of selected data of the unstructured data to at least one column of the plurality of columns. Multiple mappings of a given column are automatically resolved to provide a revised mapping output, based on there being more than one mapping of the given column. One or more actions are performed based on, at least, one of the mapping output and the revised mapping output.

Computer systems and computer program products relating to one or more aspects are also described and may be claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present invention;

FIG. 2A depicts one example of sub-modules of a data mapping module of FIG. 1, in accordance with one or more aspects of the present invention;

FIG. 2B depicts one example of a structured data processing sub-module of FIG. 2A, in accordance with one or more aspects of the present invention;

FIG. 2C depicts one example of an unstructured data processing sub-module of FIG. 2A, in accordance with one or more aspects of the present invention;

FIG. 3 depicts one example of data mapping, in accordance with one or more aspects of the present invention;

FIG. 4 depicts examples of data mapping techniques, in accordance with one or more aspects of the present invention; and

FIG. 5 depicts one example of a machine learning training system used in accordance with one or more aspects of the present invention.

### DETAILED DESCRIPTION

In one or more aspects, a capability is provided to map data across different datasets and/or across different systems to relate data of various datasets and/or systems. In one aspect, a data mapping engine is provided that automatically (e.g., using one or more computing devices rather than manually) relates columns in different datasets to each other, as well as unstructured data in various datasets to columns. Mapping the data inside the datasets to one another facilitates an understanding of the data flowing between the datasets and analysis of the data. Data storage, analysis and use of the data are facilitated, improving processing within a computing device.

In one or more aspects, a column of a dataset is a list of data items (e.g., values) belonging to a particular field. The column may be arranged vertically, horizontally or in another arrangement. A dataset may be any collection of data and may include structured data and/or unstructured data. In one example, a dataset may be in tabular form and include one or more tables, each having one or more columns. In another example, a dataset includes unstructured data, such as sentences, paragraphs, text, comments, etc. Various examples of datasets are possible.

In one or more aspects, the data mapping includes stepwise element-wise mapping, label mapping and syntactic matching recommendations to provide mapping for a maximum number of columns in the datasets. The data mapping includes, for instance, mapping structured and unstructured data of the datasets.

In one or more aspects, the data mapping engine is automatically trained to perform the data mapping to maximize the mapping. In one or more aspects, the training of the data mapping engine includes using historical data maps and creating and saving new data maps for additional learning and training. A trained model used in the training of the data mapping engine is re-trained based on feedback from both the structured and unstructured data mapping for various datasets.

One or more aspects of the present invention are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) that, e.g., performs data mapping and/or performs one or more other aspects of the present invention. Aspects of the present invention are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

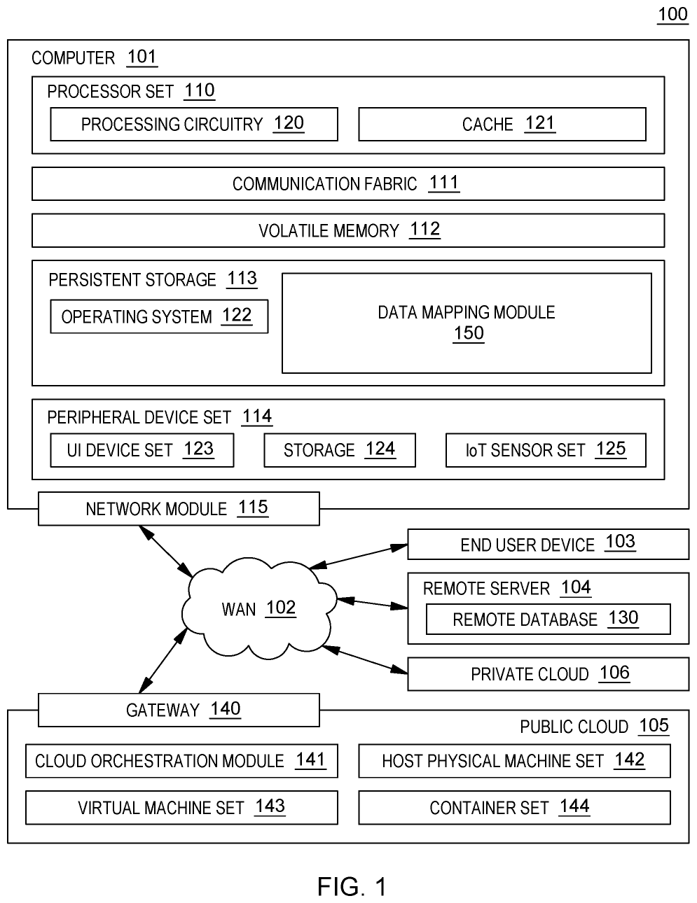

One example of a computing environment to perform, incorporate and/or use one or more aspects of the present invention is described with reference to FIG. 1. In one example, a computing environment 100 contains an example of an environment for the execution of at least some of the computer code involved in performing the inventive methods, such as data mapping code or module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present invention. Other examples are possible. For instance, in one or more embodiments, one or more of the components/modules of FIG. 1 are not included in the computing environment and/or are not used for one or more aspects of the present invention. Further, in one or more embodiments, additional and/or other components/modules may be used. Other variations are possible.

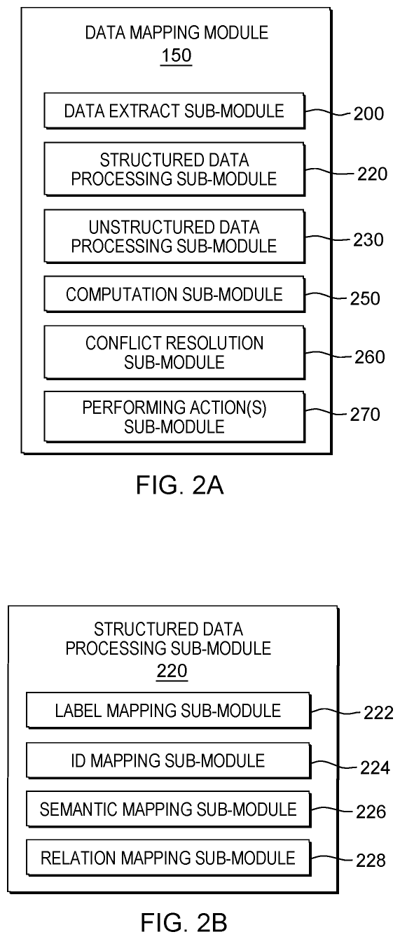

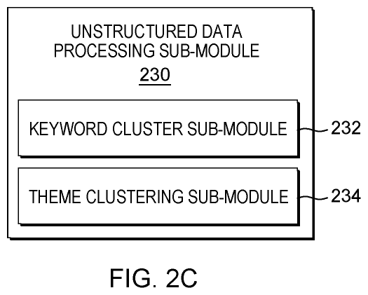

Further details relating to data mapping are described with reference to FIGS. 2A-2C. FIGS. 2A-2C depict further details of a data mapping module (e.g., data mapping module 150 of FIG. 1) that includes code or instructions used to perform data mapping, in accordance with one or more aspects of the present invention.

In one or more aspects, referring to FIG. 2A, a data mapping module (e.g., data mapping module 150) includes, in one example, various sub-modules to be used to perform data mapping and/or to perform tasks relating thereto. The sub-modules are, e.g., computer readable program code (e.g., instructions) in computer readable media, e.g., storage (storage 124, persistent storage 113, cache 121, other storage, as examples). The computer readable media may be part of a computer program product and the computer readable program code may be executed by and/or using one or more computing devices (e.g., one or more computers, such as computer(s) 101; one or more servers, such as remote server(s) 104; one or more processors or nodes, such as processor(s) or node(s) of processor set 110; processing circuitry, such as processing circuitry 120 of processor set 110; and/or other computing devices, etc.). Additional and/or other computers, servers, processors, nodes, processing circuitry and/or other computing devices may be used to execute one or more of the sub-modules and/or portions thereof. Many examples are possible.

Example sub-modules of data mapping module 150 include, for instance, a data extract sub-module 200 to extract data to be mapped; a structured data processing sub-module 220 to process extracted structured data, including performing mapping of the structured data; an unstructured data processing sub-module 230 to process extracted unstructured data, including performing mapping of the unstructured data; a computation sub-module 250 to compute column weights for mappings provided by the structured and/or unstructured data processing; a conflict resolution sub-module 260 to optionally perform conflict resolution of mapped data; and a perform action(s) sub-module 270 to be used to perform one or more actions relating to the mapping, including but not limited to, training/re-training an artificial intelligence model used to perform the data mapping. Although various sub-modules are described, a data mapping module, such as data mapping module 150, may include additional, fewer and/or different sub-modules. A particular sub-module may include additional code, including code of other sub-modules, less code, and/or different code. Further, additional and/or other modules may be used to perform data mapping and/or related tasks. Many variations are possible.

Further details relating to structured data processing sub-module 220 are described with reference to FIG. 2B and further details relating to unstructured data processing sub-module 230 are described with reference to FIG. 2C.

Referring to FIG. 2B, in one example, structured data processing sub-module 220 includes a label mapping sub-module 222 to perform label mapping of the structured data (e.g., mapping of column labels); an id (identification) mapping sub-module 224 to perform identification mapping of the structured data; a semantic mapping sub-module 226 to perform semantic mapping of the structured data; and a relation mapping sub-module 228 to perform relation (also referred to as relationship) mapping of the structured data, each of which is further described below.

Referring to FIG. 2C, in one example, unstructured data processing sub-module 230 includes a keyword clustering sub-module 232 to perform keyword clustering of the unstructured data; and a theme clustering sub-module 234 to perform theme clustering of the unstructured data, each of which is further described below.

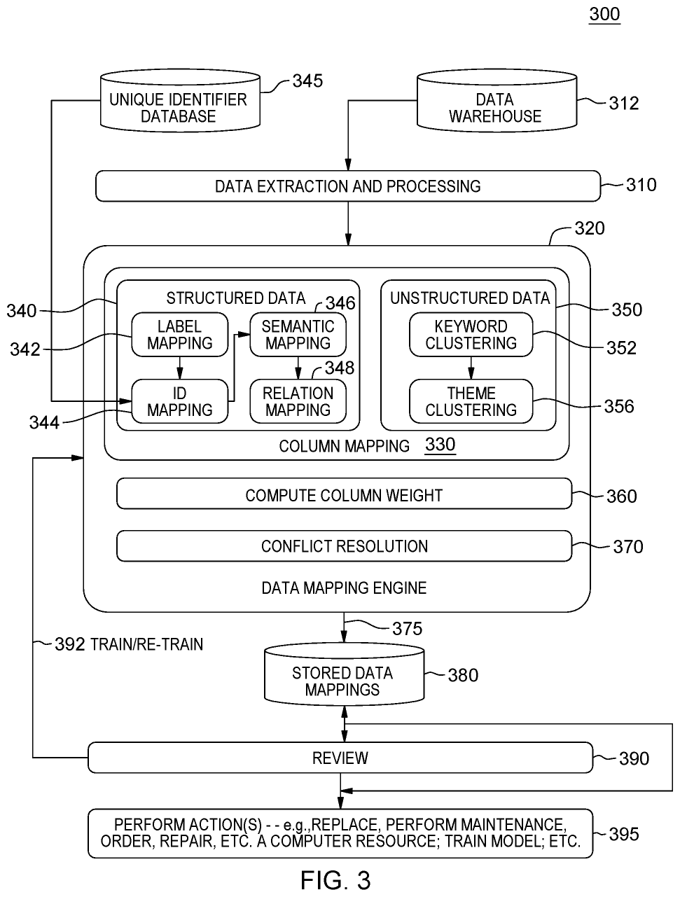

The sub-modules are used, in accordance with one or more aspects of the present invention, to perform data mapping and/or other tasks related thereto, as further described with reference to FIG. 3. In one example, a data mapping process (e.g., a data mapping process 300) is implemented using one or more of the sub-modules (e.g., one or more of sub-modules 200-270) and is executed by one or more computing devices (e.g., one or more computers (e.g., computer(s) 101, other computer(s), etc.), one or more servers (e.g., server(s) 104, other server(s), etc.), one or more processor(s), node(s) and/or processing circuitry, etc. (e.g., of processor set 110 or other processor sets), and/or other computing devices, etc.). Although example computers, servers, processors, nodes, processing circuitry and/or computing devices are provided, additional, fewer and/or other computers, servers, processors, nodes, processing circuitry and/or computing devices may be used for the data mapping process and/or other processing. Various options are possible.

In one example, referring to FIG. 3, process 300 performs 310 data extraction and processing. For example, it extracts data to be mapped from, for instance, a data warehouse 312. In one example, data warehouse 312 is a repository for data from disparate sources. The data may be structured data in one or more structured datasets and/or unstructured data in one or more unstructured datasets. As an example, structured datasets may be in the form of tables or other defined data structures, and unstructured data may be in free form, such as natural language comments, sentence form, text, e-mail exchanges, etc. In one example, the unstructured data is, tokenized in which articles and similar types of words (e.g., a, an, the, of, etc.) are removed.

Each type of dataset (e.g., structured dataset, unstructured dataset) may employ different extraction and processing actions. For example, with structured datasets, such as tables that include columns, the column labels and their values are extracted from structured data available in tabular form. In one example, the column labels and their corresponding values are validated. For example, if a column label or the value in that column is null, then it is not considered as input to the processing and/or model training (e.g., the training of the model used to train the data mapping engine (e.g., data mapping engine 320). Further, in one example, for unstructured datasets, the unstructured data is parsed to extract keywords. Additional and/or other processing may be performed.

The validated column labels and values and the extracted keywords are input to a data mapping engine (e.g., data mapping engine 320). In one example, process 300 processes the extracted data using a plurality of mapping actions that compose data mapping engine 320. For instance, process 300 performs 330 column mapping on the structured and unstructured data. As an example, for the structured data, process 300 performs 340 one or more of label mapping 342, id (identification) mapping 344, semantic mapping 346 and/or relation mapping 348, each of which is described below.

In one example, label mapping 342 includes determining whether a column label in one dataset is the same or similar to column labels in other datasets. It is syntax-driven, where the column labels that are the same or very similar (e.g., as defined by one or more rules) across multiple datasets are mapped together. For instance, assume a column of a dataset has a label of processor name (e.g., ProcessorName) in one table, then other structured data structures (e.g., other tables) are searched for other columns with the same or similar label to processor name (e.g., ProcessorName, processor_name, etc.). Processor name is only one example; many other labels may be searched. Many examples are possible.

Id mapping 344 includes, for instance, correlating an identification (id) with a name. For instance, a country id may be correlated to a particular country. For instance, a country id of “nn” correlates to one country, such as the United States, where “nn” are two numbers, letters, etc. Many other examples are possible, including, but not limited to, different sizes or indications for the id. In an example, id mapping is performed subsequent to label mapping for the remaining unmapped column labels that store unique identifier information. Id mapping is also a syntax-based technique. As an example, a unique identifier definition database (e.g., unique identifier database 345) includes the mapping of file identifiers taken from dataset descriptions for matching with the respective definitions of column labels to bring more context to the data. Such unique identifier definitions may be readily available as part of the data source definitions. Additionally, they can be learned over time and reused across datasets.

In one example, the description of the identifier may be used instead of using the identifier, which may be an encoded value. As an example, one table may have a column referred to as country id and the column includes different country identifiers. In order to provide meaning to the country identifiers in the table, another table referred to, for instance, as a country table, is searched for the country identifiers in the one table to locate the country name. Many other examples are possible.

In one example, semantic mapping 346 includes searching the structured data for semantically similar column values, based on, e.g., one or more dictionaries. For instance, assume a structured data item of “server,” semantic mapping may indicate, for instance, particular brands of servers. Many other examples are possible. In one example, semantic mapping is performed subsequent to label and id mapping. For instance, the remaining unmapped labels are evaluated using semantic similarity between the column values. This similarity is useful when matching product components between, e.g., components (e.g., servers, processors, etc.) owned by an entity and, e.g., maintenance schedule; orders and invoices; etc. Such product components may include sub-product items that are indicated in one or more datasets (e.g., ownership table; maintenance schedule table; order table; invoice table; etc.). Semantic similarity between sub-product components helps map the columns between the datasets. In one example, the similar sub-product components are identified using the vector distance between the values in the column using cosine similarity. The angle determines the degree of similarity between the components. The output of this mapping is the mapping of similar column values that can be mapped to each other. For example, product components like server, processor, security, etc. may be semantically related, which aids in the data mapping of the columns. Other variations are possible.

Relation mapping 348, in one example, includes determining data that are similar to other data based on, for instance, a history of synonymous terms and/or other information. For example, assume a structured data column of “region,” relation mapping may indicate, based on, e.g., history, that a synonymous term is “country.” Many other examples are possible. In one example, relation mapping is performed after the other mappings. For the remainder of the unmapped columns, an objective is to find the most correlated columns, and analyze whether they share a linear or non-linear relationship with each other. For each of the remainder column pairs, a correlation technique is computed. For instance, the Pearson coefficient correlation may be computed and, e.g., a column “server” from one dataset and, e.g., a column “server id” from another dataset may be determined to be linearly related. The Pearson coefficient correlation analysis is conducted between column labels and values to find the most correlated columns in the datasets. The columns are considered highly correlated if their correlation coefficient score is above a predefined threshold. The mapping relationship between columns is based on these highly correlated columns. If the relationship between columns x and y is linear, it is denoted, in one example, as follows: x->p₀+p₁y, where the linear regression is defined as x changing with respect to y. If the relationship is non-linear, a generalized additive model, as an example, is used to fit the columns and find the relationship.

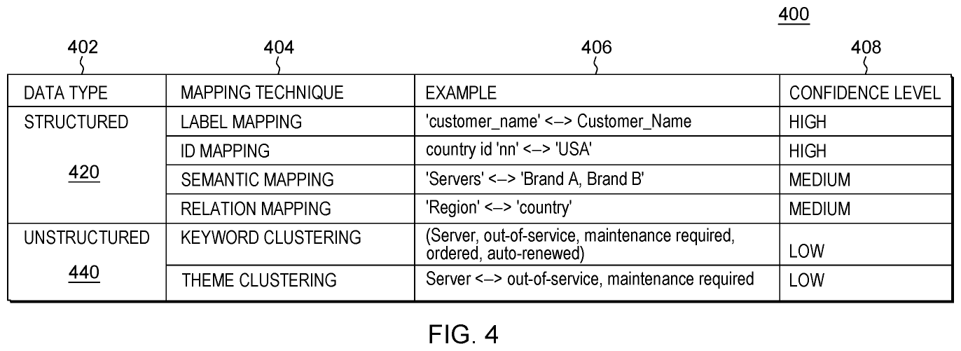

In one example, the order in which the structured data column mappings is performed is based on a confidence level of the particular technique. For instance, as shown in FIG. 4, each type of structured data mapping technique has a confidence level. For instance, a table 400 includes a plurality of columns including, as an example, a data type column 402, a mapping technique column 404, example data items column 406 and a confidence level column 408. As an example, for a structured data type 420: a label mapping technique has a high confidence level; an id mapping technique has a high confidence level; a semantic mapping technique has a medium confidence level; and a relation mapping technique has a medium confidence level. Many other examples are possible for the structured data type.

In one example, the techniques with the higher confidence level are performed before other techniques with a lower confidence level. If multiple techniques have the same confidence level, then one may be selected randomly over the other or based on predefined selection rules. Other variations are possible.

The output of the structured column mapping includes one or more (typically, a plurality of) relationships between columns, and those relationships may be stored in, e.g., a database, such as a stored data mappings database (e.g., stored data mappings 380). For instance, a relationship maybe a mapping of one column in one dataset to another column in another dataset. One column may be mapped to a plurality of columns in a plurality of datasets (at least initially). Other examples are possible.

Additionally, in one or more aspects, returning to FIG. 3, process 300 processes the unstructured data by performing 350 column mapping 330 for the unstructured data. For instance, the unstructured data is utilized to show a relation with one or more structured data columns. This mapping is performed for, e.g., the keywords extracted from the unstructured data. As examples, the column mapping of the unstructured data includes one or more of: keyword clustering 352 and/or theme clustering 356, each of which is described below.

In one example, keyword clustering 352 is performed for a word or a few words clustered together in which an attempt is made to map the word or clustered group of words to one or more features in the structured data. A determination is made, for instance, as to whether the word or group of words maps to a column name (or other label) of the structured data. There may or may not be such a mapping. In one example for keyword clustering, keywords and their definitions are obtained using one or more dictionary sources as input to a clustering model, such as a k-means clustering model (or other clustering model). For example, a keyword “server” may be clustered with selected keywords, such as “out-of-service.” “to be repaired,” “to be replaced,” “maintenance required.” “ordered.” “auto-renewed,” etc. because they show state variations of “server;” a keyword “invoice” may be clustered with “settled,” “settlement,” “bill.” “full amount paid,” etc. because such keywords indicate different states of invoices billed; etc. Many variations are possible. Additional, fewer and/or other keywords may be selected to be clustered.

Further, in one example, theme clustering 356 is performed in which terms related to a particular topic (e.g., orders, such as orders of servers, other computer resources and/or other type of orders) are clustered and the columns of the structured data are searched for the particular topic (e.g., orders, servers, etc.). If there are such mappings, they are indicated.

In one example for theme clustering, the clustered keywords are abstracted into higher-level concepts, adding more context around them. Examples of themes like server, processor, order, computer resource, invoice, communication, renewal, product, contract, where there are several clusters at the theme level. For instance, for server, the clusters may be, e.g.: {server, out-of-service}, {server, maintenance required}, etc. As another example, for order, the clusters may be, e.g.: {order, cancelled}, {order, terminated}, {order, auto-renewed}, {order, renewal}. These clusters group keywords with similar semantic meanings together.

In one example, themes are mapped to structured data columns using the semantic mapping to map to relevant column headers in the data mapping engine (e.g., data mapping engine 320). The unstructured data are to show some mapping to structured data columns to show their relationship.

In one example, a confidence level is provided based on the type of mapping. For instance, referring to FIG. 4, for an unstructured data type 440, a confidence level 408 of low is applied to both the keyword clustering and the theme clustering, in one example.

Returning to FIG. 3, for each mapping that is performed (e.g., mapping of a column in one dataset to a column in one or more other datasets, mapping of a keyword(s)/theme(s) to one or more columns), in one example, process 300 computes 360 one or more column weights. For instance, a weighting function is used to identify the confidence score of the mapping between columns and/or keyword(s)/themes to columns. This weighting function depends on the confidence level (e.g., confidence level 408) associated with the type of technique used to establish the mapping. In one example, it also factors in the number of different techniques that recommended the same mapping between columns and/or keyword(s)/themes to columns to boost the confidence score. One example of a weighting function can be defined in the below equation:

W_c=Σf(cf,n_t)

where W_c is the weight of the column c, cf is the confidence level and n_t is the number of mapping techniques that recommended the same mapping. The output of this computation is to provide weights to columns mapped and stored in the data mappings database (e.g., stored data mappings 380).

In one or more aspects, process 300 performs 370 conflict resolution, providing one or more data mappings that process 300 stores 375 in one or more repositories, such as stored data mappings 380. In one example, the data mapping engine is to attempt to achieve a one-to-one mapping between data columns. In some cases, the data mapping engine provides multiple mappings between columns, due to mapping techniques that may intersect with each other. Therefore, the weights computed above are utilized to identify the most relevant mapping between columns. For example, the column mapping with a maximum confidence score (as compared to the other confidence scores of related column mappings) is selected as the final mapping. The final mappings are stored, in one example, in stored data mappings 380. In one example, the conflict resolution processing is optional since if, for instance, there are no multiple mappings of a column, then this task need not be performed. Other examples are also possible.

The one or more data mappings output from data mapping engine 320 (e.g., before or after conflict resolution) may be reviewed 390, in one or more embodiments, manually and/or automatically. In one example, one or more subject matter experts who have domain-specific knowledge and expertise around the datasets facilitate analysis of the identified mappings between the datasets. For example, in the computer industry, a subject matter expert may be a member of a computer team that maintains servers and server data. The subject matter expert can analyze the multiple mappings and validate if the mappings are incorrect due to reasons not factored in by the data mapping engine. Examples of discrepancies can be erroneous spelling mistakes leading to incorrect mappings, mixing up definitions of the same terms, such as ‘terminated’ and ‘closed’ etc. The subject matter expert can also iterate on a set of defined mapping rules and point out if discrepancies in data are leading to inaccurate mappings.

In another example, the review may be performed automatically using, for instance, a trained artificial intelligence model trained in domain-specific knowledge. The trained model may review the mappings and determine whether a particular mapping is valid or invalid. This trained model is continuously trained and learns from input to the training that further refines the domain-specific knowledge.

The output of the review is the final output of the system, which is, for instance, one or more mappings between columns and/or keyword(s)/themes in structured and unstructured datasets. For instance, the final output may include a plurality of mappings, in which each mapping is a mapping of one column in one dataset to another column in another dataset or a mapping of unstructured data (e.g., a keyword or theme) to a column in a dataset. Other examples are possible.

In one example, the final output is stored in a data repository, such as stored data mappings database 380. This output may be used for many tasks, including, but not limited to, performing risk analysis using the data mappings. For instance, one or more data mappings may be used to determine that a particular computer resource in a production computing environment is to have maintenance performed or its contract is about to expire, etc. Many variations are possible.

In one or more aspects, output of the review (e.g., the one or more final mappings) may be used to train/re-train 392 data mapping engine 320. For instance, the data mapping engine is trained using, for instance, a trained model that is trained using machine learning and one or more training datasets. The trained model is evaluated using one or more test sets. The trained model may be repeatedly and/or continuously trained by inputting the output of review 390 to the trained model of the data mapping engine and/or to the data mapping engine itself. This enables the data mapping model/engine to learn from the output of the review. This review output may include indications of correct mappings, incorrect mapping, inconclusive mappings, etc. Based on providing the input to the data mapping engine, one or more actions of the data mapping may be repeated to output one or more additional, fewer and/or other data mappings. This process may be repeated one or more times to obtain data mappings that meet one or more selected criterion. Many variations are possible.

In one or more aspects, either after review or without review, one or more actions are initiated and/or performed 395. Example actions that are at least initiated automatically and may be performed (e.g., automatically, manually) include, e.g., replacing, repairing, performing maintenance of a computer resource (e.g., server, processor, computer component, etc.); ordering and/or invoicing a computer resource or other physical component and/or service; re-training the artificial intelligence model used to train the data mapping engine, thus re-training the data mapping engine, etc. Many other examples are possible.

In one or more aspects, a data mapping engine is provided that enables data from data warehouses to be reviewed and mapped to facilitate analysis of events, including, but not limited to, use/re-use of computer resources and/or other events that use data stored in the data warehouses.

Described above is one example of data mapping. One or more aspects of the process may use machine learning. For instance, machine learning may be used to train the data mapping engine model, determine mappings, learn from previous mappings, and/or perform other tasks. A system is trained to perform analyses and learn from input data and/or choices made.

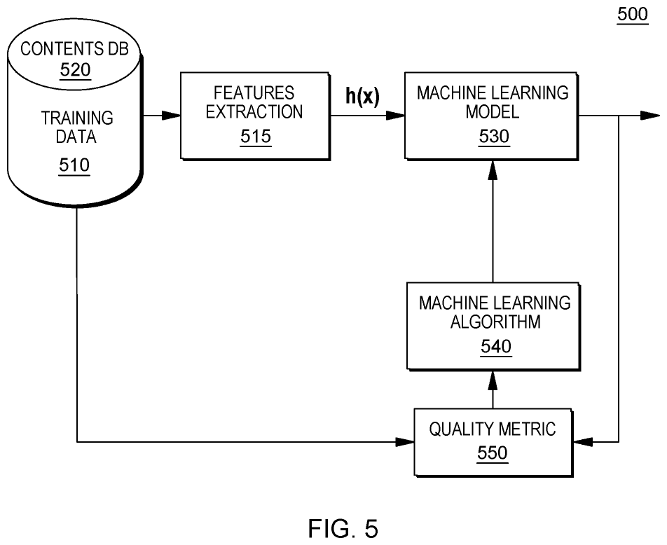

FIG. 5 is one example of a machine learning training system 500 that may be utilized, in one or more aspects, to perform cognitive analyses of various inputs, including data mappings, data from one or more datasets and/or other data. Training data utilized to train the model in one or more embodiments of the present invention includes, for instance, data that pertains to one or more resources/events, previous data mappings, indications of accuracy of data mappings, etc. The program code in embodiments of the present invention performs a cognitive analysis to generate one or more training data structures, including algorithms utilized by the program code to predict states of a given event. Machine learning (ML) solves problems that are not solved with numerical means alone. In this ML-based example, program code extracts various attributes from ML training data 510 (e.g., historical data collected from various data sources relevant to the event), which may be resident in one or more databases 520 comprising event or task-related data and general data. Attributes 515 are utilized to develop a predictor function, h (x), also referred to as a hypothesis, which the program code utilizes as a machine learning model 530.

In identifying various event states, features, constraints and/or behaviors indicative of states in the ML training data 510, the program code can utilize various techniques to identify attributes in an embodiment of the present invention. Embodiments of the present invention utilize varying techniques to select attributes (columns, labels, elements, patterns, features, constraints, distribution, etc.), including but not limited to, diffusion mapping, principal component analysis, recursive feature elimination (a brute force approach to selecting attributes), and/or a Random Forest, to select the attributes related to various events. The program code may utilize a machine learning algorithm 540 to train the machine learning model 530 (e.g., the algorithms utilized by the program code; e.g., the data mapping engine model), including providing weights for the conclusions, so that the program code can train the predictor functions that comprise the machine learning model 530. The conclusions may be evaluated by a quality metric 550. By selecting a diverse set of ML training data 510, the program code trains the machine learning model 530 to identify and weight various attributes (e.g., labels, features, patterns, constraints, distributions, etc.) that correlate to various states of an event.

The model generated by the program code is self-learning as the program code updates the model based on active event feedback, as well as from the feedback received from data related to the event. For example, when the program code determines that there is an event (e.g., incorrect mapping, inconclusive mapping, etc.) that was not previously predicted by the model, the program code utilizes a learning agent to update the model to reflect the state of the event, to improve predictions in the future. Additionally, when the program code determines that a prediction is incorrect, either based on receiving user feedback through an interface or based on monitoring related to the event, the program code updates the model to reflect the inaccuracy of the prediction for the given period of time. Program code comprising a learning agent cognitively analyzes the data deviating from the modeled expectations and adjusts the model to increase the accuracy of the model, moving forward.

In one or more embodiments, program code, executing on one or more processors, utilizes an existing cognitive analysis tool or agent (now known or later developed) to tune the model, based on data obtained from one or more data sources. In one or more embodiments, the program code interfaces with application programming interfaces to perform a cognitive analysis of obtained data. Specifically, in one or more embodiments, certain application programming interfaces comprise a cognitive agent (e.g., learning agent) that includes one or more programs, including, but not limited to, natural language classifiers, a retrieve and rank service that can surface the most relevant information from a collection of documents, concepts/visual insights, trade off analytics, document conversion, and/or relationship extraction. In an embodiment, one or more programs analyze the data obtained by the program code across various sources utilizing one or more of a natural language classifier, retrieve and rank application programming interfaces, and trade off analytics application programming interfaces. An application programming interface can also provide audio related application programming interface services, in the event that the collected data includes audio, which can be utilized by the program code, including but not limited to natural language processing, text to speech capabilities, and/or translation.

In one or more embodiments, the program code utilizes a neural network to analyze event-related data to generate the model utilized to predict the state of a given event at a given time. Neural networks are biologically inspired programming paradigms which enable a computer to learn and solve artificial intelligence problems. This learning is referred to as deep learning, which is a subset of machine learning, an aspect of artificial intelligence, and includes a set of techniques for learning in neural networks. Neural networks, including modular neural networks, are capable of pattern recognition with speed, accuracy, and efficiency, in situations where datasets are multiple and expansive, including across a distributed network, including but not limited to, cloud computing systems. Modern neural networks are non-linear statistical data modeling tools. They are usually used to model complex relationships between inputs and outputs or to identify patterns in data (i.e., neural networks are non-linear statistical data modeling or decision making tools). In general, program code utilizing neural networks can model complex relationships between inputs and outputs and identify patterns in data. Because of the speed and efficiency of neural networks, especially when parsing multiple complex datasets, neural networks and deep learning provide solutions to many problems in multiple source processing, which the program code in one or more embodiments accomplishes when obtaining data and generating a model for predicting states of a given event.

In one or more aspects, a data mapping engine/process is provided that receives as input datasets that include structured data, as well as unstructured data, and provides as output one or more mappings between columns in the structured datasets and/or unstructured data in the unstructured datasets to one or more columns of structured data. In one or more aspects, structured data and unstructured data are extracted from one or more datasets and input to a data mapping engine. The data mapping engine performs column mapping for the structured and the unstructured data. The data mapping for the structured data includes, for instance, label mapping, id mapping, semantic mapping and/or relation mapping; and the data mapping for the unstructured data includes, for instance, keyword clustering and/or theme clustering. The output of the column mapping provides one or more mappings in which column weights are computed for the one or more mappings. Conflict resolution is performed based on the column weights to provide one or more final mappings. A review of the final mappings may be performed. A result of the review is output and is used, in one or more aspects, to perform one or more actions, including, but not limited to, further training of the data mapping engine.

In one or more aspects, a data mapping engine/process is provided that addresses the lack of standardization in the use and/or storing of data within and/or across organizations, industries, etc. For instance, similar terms have different names in the various datasets. As an example, different organizations within the same industry may utilize different entity definitions for the terms that are synonymous with similar semantic meanings. An entity includes, for instance, column labels and their values, id definitions and/or keywords extracted from unstructured data. Similarly, within an organization, different departments may utilize one entity versus another department may utilize different entity definitions for the same term. For example, one dataset may use the term server, while others use computer, computing device, computer resource, etc. Many other examples exist for server and/or other terms.

Further, in one or more aspects, the data mapping engine/process automatically performs the data mapping avoiding a laborious manual process in which hours, even weeks or more, of time is spent performing the mapping to use the data and/or perform analysis of the data. This saves time and minimizes errors.

Yet further, in one or more aspects, the data mapping engine/process integrates different datasets providing mapped data that is able to be used by organizations/industries to perform analysis and/or monitoring and/or to take action based on the analysis and/or monitoring. The action may include, for instance, initiating, preparing to perform and/or performing: maintenance on a computer resource (e.g., a server, a processor, computer component, etc.), replacing a computer resource, ordering additional and/or different computer resources, etc.; training/re-training the artificial intelligence model; etc., Many examples are possible.

In one or more aspects, a data mapping engine/process is provided that uses stepwise element-wise mapping, label-wise semantic mapping and syntactic matching mapping to map data of disparate datasets. In one or more aspects, the training of the data mapping engine is automated by, e.g., performing stepwise element-wise mapping, label-wise semantic mapping and syntactic matching mapping to map data of disparate datasets. The relationship mapping between features is divided, whether linear or non-linear, and used to fit in the respective model; and/or extracted entities from text analytics are utilized and clustering is performed based on data categorization.

In one or more aspects, the data mapping engine/process utilizes learnings from historical data maps and stores newly created mappings as feedback. The model (e.g., data mapping engine model) is re-trained based on feedback for both structure and unstructured data mapping for datasets. The data mapping engine may be used for different types of datasets and/or data warehouses.

In one or more aspects, raw data is received and extracted into structured and unstructured datasets. Mapping is performed on training data and a model engine is built which maps labels (e.g., column labels). A test set is utilized to evaluate the accuracy of a mapping and the mapping rules not stored in the engine are re-iterated on using a feedback loop. Multiple mappings between columns are resolved by using a weighting function to extract the most relevant table features and label importance, as examples. A review is performed, in one example, to provide feedback on final mapping between table columns.

As an example, the performing the mapping on the data and the building a model engine includes training the data mapping model for structured data tables, building the data mapping for unstructured data, and combining the data mappings into the trained mapping engine.

In one example, the training the data mapping model for structured data tables includes performing element-wise mapping of labels, performing semantic similarity mapping, performing coefficient correlation analysis between columns, and evaluating relationships between columns based on correlations. If, e.g., the relationship is linear, a linear regression is used, in one example, to define the mapping of columns; and if, e.g., the relationship is non-linear, spline based generative additive models are used, in one example, to fit the features and define the mapping. In one example, the training of the data mapping model for the unstructured data includes performing data categorization using classification, clustering the data based on thematic topic-based classes, and/or mapping themes to mapped data and writing them to the trained mapping engine.

One or more aspects of the present invention are tied to computer technology and facilitate processing within a computer, improving performance thereof. For instance, data storage and retrieval are facilitated using, e.g., data mapping. In one or more aspects, technical fields of computing and artificial intelligence, at the very least, are improved by facilitating the analysis and mapping of vast amounts of data. Processing within a processor, computer system and/or computing environment is improved.

Other aspects, variations and/or embodiments are possible.

The computing environments described herein are only examples of computing environments that can be used. One or more aspects of the present invention may be used with many types of environments. The computing environments provided herein are only examples. Each computing environment is capable of being configured to include one or more aspects of the present invention. For instance, each may be configured to provide data mapping and/or to perform to one or more other aspects of the present invention.

In addition to the above, one or more aspects may be provided, offered, deployed, managed, serviced, etc. by a service manager who offers management of customer environments. For instance, the service manager can create, maintain, support, etc. computer code and/or a computer infrastructure that performs one or more aspects for one or more customers. In return, the service manager may receive payment from the customer under a subscription and/or fee agreement, as examples. Additionally, or alternatively, the service manager may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, other data sources and/or devices may be used, other data mapping techniques may be considered and/or other computational techniques may be used. Many variations are possible.

Various aspects and embodiments are described herein. Further, many variations are possible without departing from a spirit of aspects of the present invention. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of facilitating processing within a computing environment, the computer-implemented method comprising:
obtaining structured data and unstructured data to be mapped, the structured data including a plurality of columns;
automatically performing mapping using the structured data and the unstructured data to provide a mapping output, the mapping output including at least one mapping between a selected column of the plurality of columns and another column of the plurality of columns and a mapping of selected data of the unstructured data to at least one column of the plurality of columns;
automatically resolving multiple mappings of a given column, based on there being more than one mapping of the given column, to provide a revised mapping output; and
performing one or more actions based on, at least, one of the mapping output and the revised mapping output.

2. The computer-implemented method of claim 1, wherein the automatically performing the mapping using the structured data and the unstructured data includes performing one or more mapping techniques on the structured data to provide one or more relationships between the plurality of columns.

3. The computer-implemented method of claim 2, wherein the one or more mapping techniques include label mapping, identification mapping, semantic mapping and relation mapping.

4. The computer-implemented method of claim 3, wherein the one or more mapping techniques are performed in sequential order based on one or more confidence levels of the one or more mapping techniques.

5. The computer-implemented method of claim 2, wherein the automatically performing the mapping using the structured data and the unstructured data includes performing at least one other mapping technique on one or more keywords extracted from the unstructured data to show a relationship with the at least one column of the plurality of columns.

6. The computer-implemented method of claim 5, wherein the at least one other mapping technique includes keyword clustering and theme clustering.

7. The computer-implemented method of claim 1, further comprising performing a weighting function to identify one or more confidence scores for the mapping output and using the one or more confidence scores in the automatically resolving the multiple mappings to provide the revised mapping output.

8. The computer-implemented method of claim 7, further comprising analyzing the revised mapping output for mapping inaccuracies to provide a final output of one or more column mappings based on the structured data and the unstructured data.

9. The computer-implemented method of claim 1, wherein the automatically performing the mapping using the structured data and the unstructured data to provide the mapping output is performed by a data mapping engine, the data mapping engine trained using a trained artificial intelligence model.

10. The computer-implemented method of claim 9, wherein the performing the one or more actions includes re-training the trained artificial intelligence model based on an output of one or more column mappings generated using, at least, the data mapping engine.

11. A computer system for facilitating processing within a computing environment, the computer system comprising:
a memory; and
one or more processors in communication with the memory, wherein the computer system is configured to perform a method, said method comprising:
obtaining structured data and unstructured data to be mapped, the structured data including a plurality of columns;
automatically performing mapping using the structured data and the unstructured data to provide a mapping output, the mapping output including at least one mapping between a selected column of the plurality of columns and another column of the plurality of columns and a mapping of selected data of the unstructured data to at least one column of the plurality of columns;
automatically resolving multiple mappings of a given column, based on there being more than one mapping of the given column, to provide a revised mapping output; and
performing one or more actions based on, at least, one of the mapping output and the revised mapping output.

12. The computer system of claim 11, wherein the automatically performing the mapping using the structured data and the unstructured data includes performing one or more mapping techniques on the structured data to provide one or more relationships between the plurality of columns.

13. The computer system of claim 12, wherein the automatically performing the mapping using the structured data and the unstructured data includes performing at least one other mapping technique on one or more keywords extracted from the unstructured data to show a relationship with the at least one column of the plurality of columns.

14. The computer system of claim 11, further comprising performing a weighting function to identify one or more confidence scores for the mapping output and using the one or more confidence scores in the automatically resolving the multiple mappings to provide the revised mapping output.

15. The computer system of claim 11, wherein the automatically performing the mapping using the structured data and the unstructured data to provide the mapping output is performed by a data mapping engine, the data mapping engine trained using a trained artificial intelligence model.

16. A computer program product for facilitating processing within a computing environment, said computer program product comprising:
one or more computer readable storage media and program instructions collectively stored on the one or more computer readable storage media readable by at least one processing circuit to perform a method comprising:
obtaining structured data and unstructured data to be mapped, the structured data including a plurality of columns;
automatically performing mapping using the structured data and the unstructured data to provide a mapping output, the mapping output including at least one mapping between a selected column of the plurality of columns and another column of the plurality of columns and a mapping of selected data of the unstructured data to at least one column of the plurality of columns;
automatically resolving multiple mappings of a given column, based on there being more than one mapping of the given column, to provide a revised mapping output; and
performing one or more actions based on, at least, one of the mapping output and the revised mapping output.

17. The computer program product of claim 16, wherein the automatically performing the mapping using the structured data and the unstructured data includes performing one or more mapping techniques on the structured data to provide one or more relationships between the plurality of columns.

18. The computer program product of claim 17, wherein the automatically performing the mapping using the structured data and the unstructured data includes performing at least one other mapping technique on one or more keywords extracted from the unstructured data to show a relationship with the at least one column of the plurality of columns.

19. The computer program product of claim 16, wherein the method further comprises performing a weighting function to identify one or more confidence scores for the mapping output and using the one or more confidence scores in the automatically resolving the multiple mappings to provide the revised mapping output.

20. The computer program product of claim 16, wherein the automatically performing the mapping using the structured data and the unstructured data to provide the mapping output is performed by a data mapping engine, the data mapping engine trained using a trained artificial intelligence model.
